(19) United States
(12) Patent Application Publication
(10) Pub. No.: US 2024/0142827 A1
(43) Pub. Date: May 2, 2024

(54) OPTICAL CONTROL ELEMENT

(71) Applicant: Japan Display Inc., Tokyo (JP)

(72) Inventors: Jin HIROSAWA, Tokyo (JP); Shunichi KIMURA, Tokyo (JP); Toshiharu MATSUSHIMA, Tokyo (JP); Yuji MAEDE, Tokyo (JP); Shinichi KOMURA, Tokyo (JP)

(73) Assignee: Japan Display Inc., Tokyo (JP)

(21) Appl. No.: 18/492,859

(22) Filed: Oct. 24, 2023

(30) Foreign Application Priority Data
Oct. 27, 2022 (JP) 2022-172450

(51) Int. Cl. G02F 1/1343

(52) U.S. Cl. CPC G02F 1/134309

(57) ABSTRACT

According to one embodiment, an optical control element comprises a first substrate, a second substrate, a liquid crystal layer arranged between the first substrate and the second substrate, the first substrate include a first electrode, a second electrode provided on the first electrode, and a high-resistance layer provided on the first electrode and the second electrode, wherein the second substrate comprises a third electrode, a plurality of circular apertures are provided in each of the second electrodes, and lines connecting centers of the plurality of apertures constitute a triangle.

### CROSS-REFERENCE TO RELATED APPLICATIONS

This application is based upon and claims the benefit of priority from Japanese Patent Application No. 2022-172450, filed Oct. 27, 2022, the entire contents of which are incorporated herein by reference.

### FIELD

Embodiments described herein relate generally to an optical control element.

### BACKGROUND

Liquid crystal elements capable of modulating a liquid crystal by a voltage applied between electrodes and obtaining a lens function have been developed.

### BRIEF DESCRIPTION OF THE DRAWINGS

FIG. 1 is a cross-sectional view showing an example of a schematic configuration of an optical control element.

FIG. 2 is a plan view showing an example of a schematic configuration of the optical element of the embodiment.

FIG. 3 is a plan view showing an example of the schematic configuration of the optical element of the embodiment.

FIG. 4 is a plan view showing an example of the schematic configuration of the optical element of the embodiment.

FIG. 5 is a cross-sectional view showing the optical control element along line B1-B2 shown in FIG. 4.

FIG. 6 is a cross-sectional view showing the optical control element along line C1-C2 shown in FIG. 4.

### DETAILED DESCRIPTION

In general, according to one embodiment, an optical control element comprises:
a first substrate;
a second substrate;
a liquid crystal layer arranged between the first substrate and the second substrate,
the first substrate comprising:
a first electrode;
a second electrode provided on the first electrode; and
a high-resistance layer provided on the first electrode and the second electrode, wherein
the second substrate comprises a third electrode,
a plurality of circular apertures are provided in each of the second electrodes, and
lines connecting centers of the plurality of apertures constitute a triangle.

Embodiments described herein aim to provide an optical control element with increased transparency.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same elements as those described in connection with preceding drawings are denoted by like reference numerals, and a detailed description thereof is omitted unless otherwise necessary.

The embodiments described in this specification are not general and explain the same or corresponding special technical features of the present invention. An optical control element of one embodiment will be described hereinafter with reference to the drawings.

In the embodiments, a first direction X, a second direction Y and a third direction Z are orthogonal to one another. However, they may intersect one another at an angle other than 90 degrees. A direction toward a tip of an arrow indicating the third direction Z is referred to as an upper or upward direction, and a direction opposite to the direction toward the tip of the arrow indicating the third direction Z is referred to as a lower or downward direction. The first direction X, the second direction Y and the third direction Z are also referred to as an X direction, a Y direction and a Z direction, respectively.

In addition, according to “the second member above the first member” and “the second member under the first member”, the second member may be in contact with the first member or may be located to be remote from the first member. In the latter case, a third member may be interposed between the first member and the second member. On the other hand, phrases such as “a second member on a first member” and “a second member right under a first member” refer to a case where the second member is in contact with the first member.

In addition, an observation position at which the optical control element is to be observed is assumed to be located on the tip side of the arrow indicating the third direction Z, and viewing from the observation position toward an X-Y plane defined by the first direction X and the second direction Y is referred to as plan view. Viewing a cross-section of the optical control element on an X-Z plane defined by the first direction X and the third direction Z or a Y-Z plane defined by the second direction Y and the third direction Z is referred to as cross-sectional view.

### Embodiment

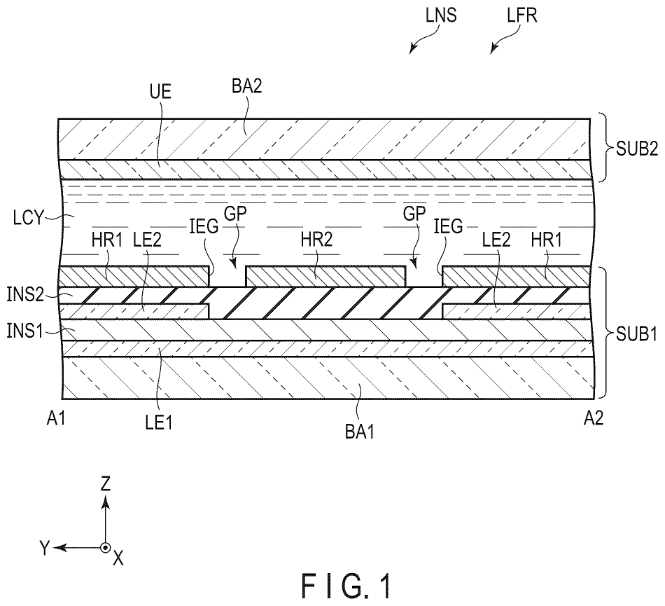

FIG. 1 is a cross-sectional view showing an example of a schematic configuration of an optical control element. An optical control element LNS shown in FIG. 1 comprises a substrate SUB1, a substrate SUB2, and a liquid crystal layer LCY provided between the substrate SUB1 and the substrate SUB2. The substrate SUB1 comprises a base BA1, an insulating layer INS1, an electrode LE1, an insulating layer INS2, an electrode LE2, a high-resistance layer HR1, and a high-resistance layer HR2. The substrate SUB2 comprises a base BA2 and an electrode UE.

The optical control element LNS shown in FIG. 1 modulates the liquid crystal layer LCY by a voltage applied among the electrode LE1, the electrode LE2, and the electrode UE and forms a lens. In other words, the optical control element LNS is a liquid crystal lens. In the embodiment, the electrode LE1, the electrode LE2, the electrode UE, and the liquid crystal layer LCY are referred to as a lens forming area LFR. In FIG. 1, only one lens forming area LFR is shown, but the optical control element LNS comprises a plurality of lens forming areas LFR. A display device capable of adjusting light emitted from pixels of a display panel can be achieved by combining the liquid crystal lens with the display panel, for example, a liquid crystal display panel.

In the substrate SUB1, the electrode LE1 is provided on the base BA1. The electrode LE1 may be what is called a solid film provided over the entire surface of the base BA1. The insulating layer INS1 is provided to cover the electrode LE1.

Two electrodes LE2 are provided on the insulating layer INS1, for example, to be separated from each other in a direction parallel to the second direction Y. As will be described later in detail, the two electrodes LE2 are integrally formed and constitute one electrode LE2.

The insulating layer INS2 is provided to cover the electrode LE2 and the insulating layer INS1. The high-resistance layer HR1 and the high-resistance layer HR2 are provided on the insulating layer INS2. The high-resistance layer HR1 is opposed to the electrode LE2 along the third direction Z. It can be said that the high-resistance layer HR1 is formed on the electrode LE2 to sandwich the insulating layer INS2. In FIG. 1, two high-resistance layers HR1 are shown, but the layers are integrally formed and constitute one high-resistance layer HR1, similarly to the electrode LE2.

The high-resistance layer HR2 is provided between the two electrodes LE2. The high-resistance layer HR2 is not opposed to the electrode LE2 along the third direction Z. A gap GP is arranged between the high-resistance layer HR2 and the high-resistance layer HR1.

When the high-resistance layer HR1 and the high-resistance layer HR2 are not specifically distinguished from each other, the high-resistance layers are hereinafter simply referred to as high-resistance layers HR. A voltage gradation for forming the liquid crystal lens can be applied by providing the high-resistance layers HR.

In the substrate SUB2, the electrode UE is provided so as to be in contact with the base BA2. An alignment film is provided so as to be in contact with the electrode UE and the liquid crystal layer LCY though not illustrated in FIG. 1. In the substrate SUB1 as well, the alignment film (not shown) is provided to cover the high-resistance layer HR1, the high-resistance layer HR2, and the insulating layer INS2. The alignment film provided in the substrate SUB1 is also in contact with the liquid crystal layer LCY.

The base BA1 and the base BA2 may be, for example, translucent insulating materials, more specifically, glass. The insulating layer INS1 may be, for example, an insulating layer containing silicon, more specifically, a silicon oxide layer or a silicon nitride layer. The electrode LE1, the electrode LE2, and the electrode UE may be transparent conductive layers, for example, transparent conductive layers containing indium tin oxide (ITO) or indium zinc oxide (IZO). The insulating layer INS2 may be, for example, an insulating layer containing silicon, more specifically, a silicon oxide layer.

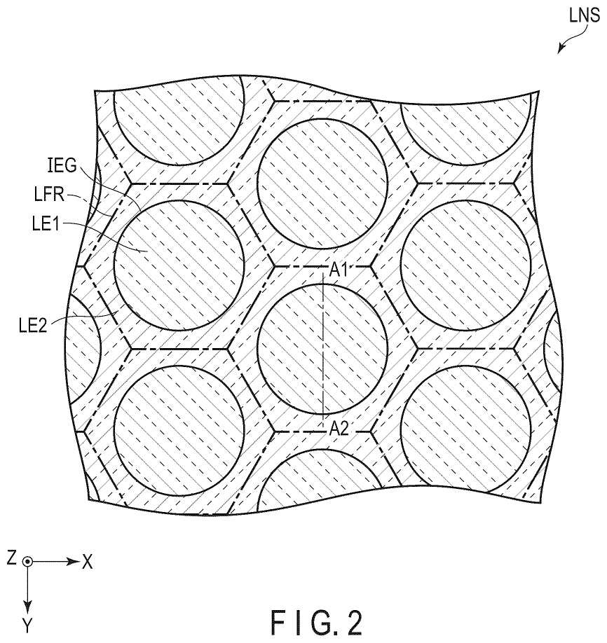

FIG. 2 is a plan view showing an example of a schematic configuration of the optical element of the embodiment. The example shown in FIG. 2 shows a planar arrangement of the electrodes LE1 and the electrodes LE2. The cross-sectional view of the optical control element LNS along line A1-A2 shown in FIG. 2 is FIG. 1.

The electrode LE1 is the solid film as described above and is provided to spread over the X-Y plane.

Similarly to the electrode LE1, the electrode LE2 is formed as the solid film in the plurality of lens forming areas LFR. As shown by a one-dot chain line, the electrode LE2 corresponding to one lens forming area LFR is assumed to have, for example, a hexagonal shape. The electrode LE2 in one lens forming area LFR includes an aperture whose inner end portion has a circular shape. In one lens forming area LFR, the electrode LE2 has a hexagonal shape as shown by the one-dot chain line, and the electrode LE2 can form a honeycomb structure in the plurality of lens forming areas LFR. In other words, the hexagonal electrodes LE2 are regularly arranged without gaps and are formed of the solid films in the plurality of lens forming areas. The electrode LE2 is arranged along the first direction X between two apertures adjacent to each other along the second direction Y. Lines connecting centers of the three apertures constitutes a regular triangle.

Since the electrode LE2 defining one lens forming area LFR has the hexagonal shape as shown by the one-dot chain line, no gap is formed between the two adjacent electrodes LE2. In other words, the adjacent electrodes LE2 are connected to each other, and one electrode LE2 is constituted in the plurality of lens forming areas LFR and includes one aperture per one lens forming area LFR.

The inner end portion of the electrode LE2 is referred to as IEG. The shape of the end portion IEG is the circular shape as described above, and the end portion IEG defines the above aperture. An electric field is generated between the electrode LE1 provided on a lower side and the electrode LE2 on an upper side via the circular aperture. The liquid crystal layer LCY is driven by the electric field to form the liquid crystal lens.

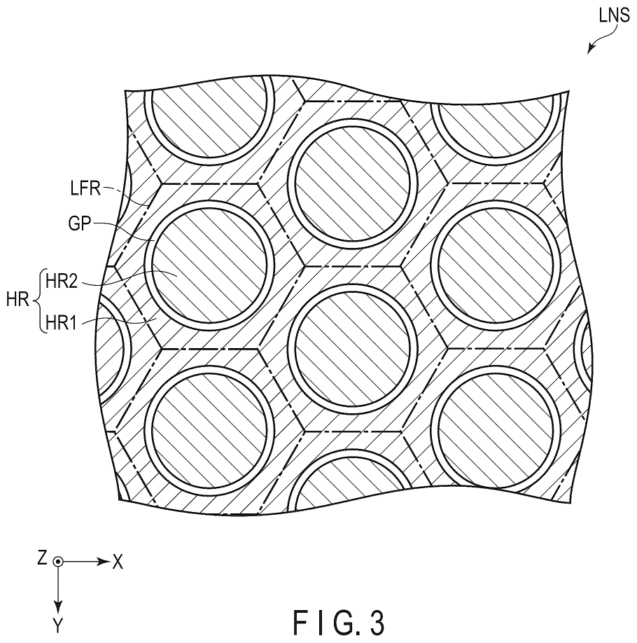

FIG. 3 is a plan view showing an example of the schematic configuration of the optical element of the embodiment. The example shown in FIG. 3 shows a planar arrangement of the high-resistance layers HR.

In the plurality of lens forming areas LFR, the high-resistance layer HR includes the high-resistance layer HR1 formed in a pattern of the solid film substantially similar to a pattern of the electrode LE2, and the high-resistance layer HR2 having the circular shape and provided to overlap with the aperture of the electrode LE2. The high-resistance layer HR1 is the solid film having a planar shape similar to the electrode LE2 and includes the plurality of apertures similarly to the electrode LE2. The high-resistance layer HR1 overlaps with the electrode LE2 in planar view. The circular shape of the high-resistance layer HR2 is smaller than the circular shape of the end portion IEG (shape of the aperture). It can be said that the high-resistance layer HR2 and the aperture are concentrically arranged.

The annular gap GP is provided between the high-resistance layer HR1 and the high-resistance layer HR2. An outer end portion of the gap GP corresponds to the end portion IEG in planar view.

In the optical control element LNS in the embodiment, the base BA1, the electrode LE1, the insulating layer INS1, the electrode LE2, the insulating layer INS2, the high-resistance layer HR, the base BA2, and the electrode UE are formed of transparent materials. Since the electrode LE1 and the electrode LE2 are formed of the solid films in the plurality of lens forming areas LFR, there is no need to provide a wire for each of the electrode LE1 and the electrode LE2 in the plurality of lens forming areas LFR. As a result, transparency of the optical control element LNS can be increased.

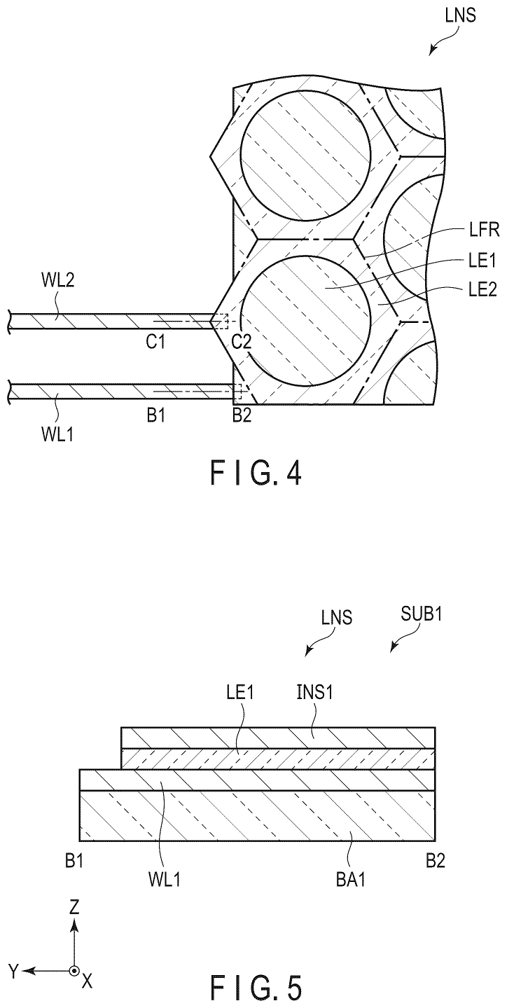

FIG. 4 is a plan view showing an example of the schematic configuration of the optical element of the embodiment. FIG. 4 shows a wire WL1 connected to the electrode LE1 and a wire WL2 connected to the electrode LE2. The wire WL1 and the wire WL2 may be provided in a peripheral area of an area in which the plurality of lens forming areas LFR are provided.

FIG. 5 is a cross-sectional view showing the optical control element along line B1-B2 shown in FIG. 4. As shown in FIG. 5, the wire WL1 is provided on the base BA1. The electrode LE1 is provided on the wire WL1 so as to be in contact with the wire WL1. In other words, the wire WL1 is provided between the base BA1 and the electrode LE1. The insulating layer INS1 is provided on the electrode LE1.

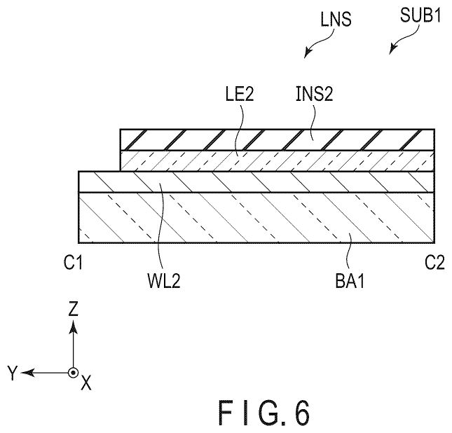

FIG. 6 is a cross-sectional view showing the optical control element along line C1-C2 shown in FIG. 4. As shown in FIG. 6, the wire WL2 is provided on the base BA1. The electrode LE2 is provided on the wire WL2 so as to be in contact with the wire WL2. In other words, the wire WL2 is provided between the base BA1 and the electrode LE2. The insulating layer INS2 is provided on the electrode LE2.

The wire WL1 and the wire WL2 are provided in the peripheral area of the area in which the plurality of lens forming areas LFR are provided. Therefore, the transparency of the plurality of lens forming areas LFR is not decreased. As a result, high transparency can be maintained in the optical control element LNS.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical control element comprising:
a first substrate;
a second substrate;
a liquid crystal layer arranged between the first substrate and the second substrate,
the first substrate comprising:
a first electrode;
a second electrode provided on the first electrode; and
a high-resistance layer provided on the first electrode and the second electrode, wherein
the second substrate comprises a third electrode,
a plurality of circular apertures are provided in each of the second electrodes, and
lines connecting centers of the plurality of apertures constitute a triangle.

2. The optical control element according to claim 1, wherein
the high-resistance layer includes a first high-resistance layer and a second high-resistance layer, and
an annular gap is provided between the first high-resistance layer and the second high-resistance layer.

3. The optical control element according to claim 2, wherein
a shape of the first high-resistance layer is the same as a shape of the second electrode, and
a shape of the second high-resistance layer is a circular shape.

4. The optical control element according to claim 2, wherein
the second high-resistance layer and the apertures are concentrically arranged.

5. The optical control element according to claim 1, wherein
the high-resistance layer is indium tin oxide or indium zinc oxide.
